(19) United States
(12) Patent Application Publication
(10) Pub. No.: US 2007/0053762 A1
(43) Pub. Date: Mar. 8, 2007

(54) Fastening element for hard constructional components

(76) Inventors: Jan Allaart, Mauren (LI); Josef Glogger, Buchloe (DE); Franz-Xaver Huber, Guenzlhofen (DE); Martin Volker, Feldkirch (AT); Michael Radl, Hohenems (AT); Juergen Wieser, Kaufering (DE)

Correspondence Address: ABELMAN, FRAYNE & SCHWAB, 666 THIRD AVENUE, 10TH FLOOR, NEW YORK, NY, 10017, US

(21) Appl. No.: 11/513,294

(22) Filed: Aug. 29, 2006

(30) Foreign Application Priority Data
Sep. 2, 2005 (DE) 10 2005 000 109.2

(51) Int. Cl. F16B 37/12

(52) U.S. Cl. 411/178

(57) ABSTRACT

A fastening element (11) for hard constructional components such as, e.g., concrete, includes a cylindrical base body (12) having opposite first (14) and second (15) ends, a self-tapping thread (17) provided on the outer surface (16) of the base body (12), an inwardly located engagement element (18) for a setting bit, a receptacle opening (19) that opens toward the second end (15) facing in a direction opposite the setting direction of the fastening element (11) and that is provided with a load application, and a collar (21) provided at the second end (15) and extending radially outwardly.

### BACKGROUND OF THE INVENTION

1. Field of the Invention

The present invention relates to a fastening element for hard constructional components such as concrete, masonry and the like and including a cylindrical base body extending along a longitudinal axis and having a first end and a second end opposite the first end, a self-tapping thread provided, at least regionwise, on the outer surface of the base body, inwardly located engagement means for the setting bit, and a receptacle opening that is open toward the second end of the base body and is provided with load application means.

2. Description of the Prior Art

Fastening elements of the type described above are used for attachment of objects to the hard constructional components such as concrete, masonry, and the like. The fastening element is screwed in a preliminary formed borehole with a suitable setting bit, with the self-tapping thread forming a complementary thread in the constructional component or in the borehole wall. The fastening element is anchored in the constructional component by the undercut formed by the complementary thread. The load application means, which is provided in the receptacle opening, is formed, e.g., as an inner thread into which an attachment element, such as e.g., a threaded rod or a screw is screwed in to form an attachment. Instead of the inner thread, a bayonet joint can be used.

European Publication EP 1 536 149 A2 discloses a fastening element of a type described above. The known fastening element has a cylindrical base body extending along a longitudinal axis and having a first, facing in the setting direction, end with a bottom section and a second end opposite the first end. On the outer surface of the base body, a self-tapping thread is provided. The base body has inwardly located, engagement means for the setting bit and a receptacle opening that opens to the second end and adjoining, in the direction toward the second end and is provided with load application means.

The drawback of the above-described fastening element consists in that with a multiple adjustment by screwing the fastening element in and out, the seating and, thereby, the anchoring of the fastening element is loosened up. If subsequently attachment means, such as, e.g., a threaded rod, is screwed into an inner thread that forms the load application means, and then is screwed out, the set fastening element can eventually also be screwed out of the borehole.

Accordingly, an object of the present invention is to provide a fastening element for hard components that would have a secure seating in the borehole and would not be screwed out from the borehole as a result of the attachment means being screwed out.

### SUMMARY OF THE INVENTION

This and other objects of the present invention, which will become apparent hereinafter, are achieved by providing a fastening element of the type described above and having a collar provided at the second end of the base body and extending radially outwardly.

The collar provides an additional contact surface between the fastening element and the hard constructional component and which because of an increased friction between the fastening element and the constructional component in the set condition of the fastening element, secures the fastening element against being screwed out when it is not desired. In addition, the collar insures the setting of the fastening element in a predetermined set position, with the collar serving as a stop, preventing a too deep undesirable setting of the fastening element. The collar insures a simple visual control of the setting position of the fastening element, significantly simplifying the setting process. The collar permits to set the inventive fastening element in hollow constructional components, without the danger that the fastening element would fall, during the setting process, in a hollow chamber that is not accessible from the outside anymore and, therefore, becomes lost and cannot be used any more.

Preferably, the collar has a radial extent that is greater than a core diameter of the base body by from 8% to 35%. Thereby, the so-called “passing” into a borehole during the setting of the fastening element is prevented to a most possible extent. Under the core diameter is understood the outer diameter of the cylindrical base body without the self tapping thread or the diameter of the tread root.

Advantageously, the collar has an axial extent corresponding to from 5% to 15% of the base body. This axial extent insures an adequate stiffness, preventing an undesired deformation of the collar when the collar abuts the constructional component during a setting process.

Preferably, the collar has a circumferential outer profile which provides the collar with as large contact surface with the constructional component as possible. When a borehole is formed in a constructional component, usually, portions of the constructional component, in the right of the borehole mouth, are broken away. As a result, the borehole mouth has a so-called “outflanking cone” that extends from the outer side of the constructional component to the borehole nominal diameter. The circumferential outer profile of the collar corresponds preferably, based on the characteristics of the material of the constructional component, to the expected profile of the “outflanking cone” at the borehole mouth. E.g., the collar can have a circumferential cylindrical, conical or spherical profile.

Advantageously, the collar has a bearing surface facing toward the first end and provided with a special profile. In the set condition of the inventive fastening element, when the bearing surface abuts the constructional component, with an appropriate profile of the bearing surface, the friction between the bearing surface and the constructional component noticeably increases, which additionally protects the fastening element from being inadvertently screwed out. The profile can have a different geometry, e.g., it may include indentations or notches, saw teeth and/or knurling.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF TH DRAWINGS

The drawings show:

FIG. 1 a side view of a first embodiment of a fastening element according to the present invention;

FIG. 2 a side view of a second embodiment of a fastening element according to the present invention;

FIG. 3 a side view of a third embodiment of a fastening element according to the present invention;

FIG. 4 a detail view of a collar of the fastening element shown in FIG. 2; and

FIG. 5 a detail view of a collar of the fastening element shown in FIG. 1.

### DETAILED DESCRIPTION OF THE PREFERRED EMBODIMENTS

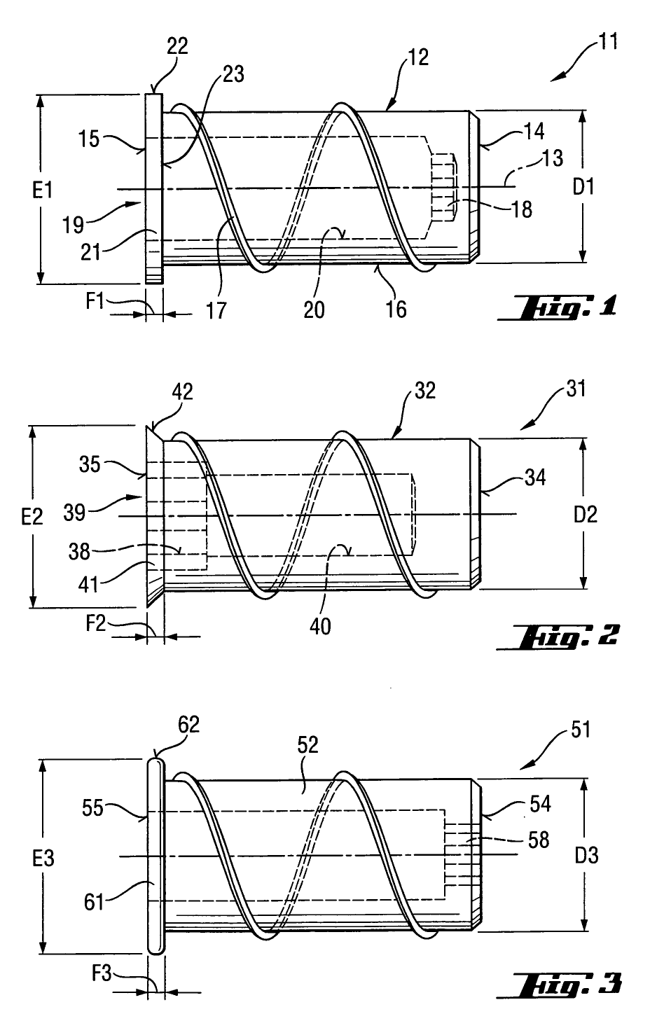

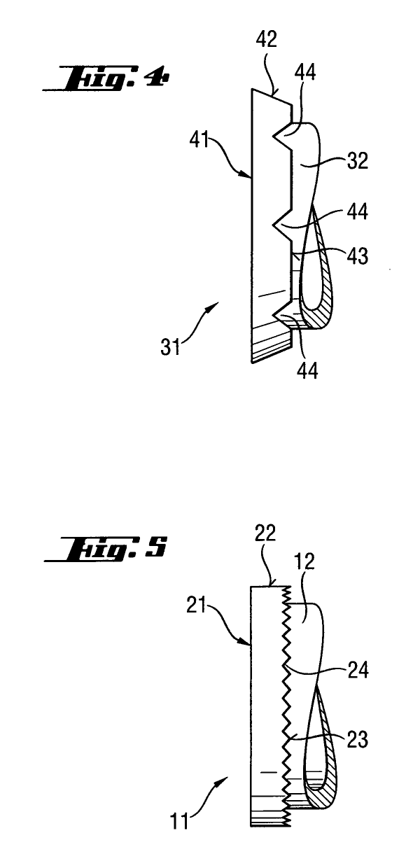

A fastening element 11 for hard constructional components, which is shown in FIG. 1, has a cylindrical base body 12 that extends along a longitudinal axis 13 and has a first end 14 and a second opposite end 15. On the outer surface 16 of the base body 12, there is provided a self-tapping thread 17. The base body 12 further has an inwardly located engagement means 18 for the setting bit and a receptacle opening 19 that opens toward the second end 15 and is provided with load application means 20 formed, e.g., as an inner thread. At the second end 15, there is provided a collar 21 projecting radially outwardly and having a cylindrical outer profile 22. The radial extent, diameter, E1 of the collar 21 is about by 20% greater than the core diameter D1 of the base body 12. The axial extent F1 of the collar 21 corresponds to about 10% of the core diameter D1 of the base body 12.

As shown in FIG. 5, the collar 21 can have a profile 24 in form of knurling on its bearing side 23 facing toward the first end 14.

A fastening element 31 for hard constructional components, which is shown in FIG. 2, corresponds substantially to the fastening element 11 shown in FIG. 1. The fastening element 31 distinguishes from the fastening element 11 in that a collar 41, which is provided at the second end 35 of the base body 32, has a circumferential conical outer profile 42. The inwardly located engagement means 38 for the setting bit is provided at the second end 35 of the base body 32. A receptacle opening 39 that opens toward the second end 35, is provided with load application means 40 adjoins the engagement means 38 and extends in the direction of the first end 34. The radial extent, diameter, E2 of the collar 41 is by about 10% greater than the core diameter D2 of the base body 32. The axial extent F2 of the collar 41 corresponds to about 15% of the core diameter D2 of the base body 12.

As shown in FIG. 4, the bearing surface 43 of the conical profile 42 that faces in the direction of the first 34, has a profile 44 in form of a plurality of indentation.

A fastening element 51 for hard constructional components differs from the above-described fastening elements in that the collar 61, which is provided at the second end 55 of the base body 52 opposite the first end 54, has a circumferential spherical profile 62, and that the engagement means 58 is provided at the first end 54 of the base body 62. The radial extent, diameter, E3 of the collar 61 is by about 30% greater than the core diameter D3 of the base body 52. The axial extent F3 of the collar 61 corresponds to about 8% of the core diameter D3 of the base body 52.

Though the present invention was shown and described with references to the preferred embodiments, such are merely illustrative of the present invention and are not to be construed as a limitation thereof and various modifications of the present invention will be apparent to those skilled in the art. It is therefore not intended that the present invention be limited to the disclosed embodiments or details thereof, and the present invention includes all variations and/or alternative embodiments within the spirit and scope of the present invention as defined by the appended claims.

What is claimed is:

1. A fastening element for hard constructional components, comprising a cylindrical base body (12; 32; 52) extending along a longitudinal axis (13) and having a first end (14; 34; 54) and an opposite second end (15; 35; 55), a self-tapping thread (17) provided, at least regionwise, on an outer surface (16) of the base body; inwardly located engagement means (18; 38; 58) for a setting bit; and a receptacle opening (19; 39) that opens toward the second end (25) and is provided with load application means (20; 40); and a collar (21; 41; 61) provided at the second end (15; 35; 55) of the base body (12; 32; 52) and extending radially outwardly.

2. A fastening element according to claim 1, wherein the collar (21; 41; 61) has a radial extent (E1; E2; E3) that is greater than a core diameter (D1; D2; D3) of the base body (12; 32; 52) by from 8% to 30%

3. A fastening element according to claim 1, wherein the collar (21; 41; 61) has an axial extent (F1; F2; F3) that corresponds to from 5% to 15% of a core diameter (D1; D2; D3) of the base body (12; 32; 52).

4. A fastening element according to claim 1, wherein the collar (21; 41; 61) has a circumferential outer profile.

5. A fastening element according to claim 1, wherein the collar (21; 41) has a bearing surface (23; 43) facing toward the first end (14; 34) and provided with a special profile (24; 44).
